(19) United States
(12) Patent Application Publication
(10) Pub. No.: US 2026/0247207 A1
(43) Pub. Date: Aug. 20, 2026

(54) AP INITIATED SCS SIGNALING

(71) Applicant: Cisco Technology, Inc., San Jose, CA (US)

(72) Inventors: Binita GUPTA, San Diego, CA (US); Brian D. HART, Sunnyvale, CA (US); Malcolm M. SMITH, Richardson, TX (US)

(21) Appl. No.: 19/369,122

(22) Filed: Oct. 24, 2025

Related U.S. Application Data
(60) Provisional application No. 63/713,849, filed on Oct. 30, 2024.

(51) Int. Cl. H04W 28/02

(52) U.S. Cl. CPC H04W 28/0268

(57) ABSTRACT

Embodiments provide a network device comprising one or more memories and one or more processors communicatively coupled to the one or more memories, wherein the one or more processors are configured to, individually or collectively, perform operations comprising transmitting a stream classification service (SCS) request to a station (STA), the SCS request comprising an SCS identifier (SCSID), a traffic classification (TCLAS) information to identify an SCS flow and a quality of service (QoS) characteristics element that indicates information for the STA to perform QoS classification or prioritization for the SCS flow, and receiving an SCS response from the STA.

### CROSS-REFERENCE TO RELATED APPLICATIONS

This application claims benefit of co-pending United States provisional patent application Serial No. 63/713,849 filed October 30, 2024. The aforementioned related patent application is herein incorporated by reference in its entirety.

### TECHNICAL FIELD

Embodiments presented in this disclosure generally relate to computer networking. More specifically, embodiments disclosed herein relate to access point (AP) initiated stream classification service (SCS) signaling.

### BACKGROUND

In a wireless network, applications running on clients or stations (STAs) may be unable to provide quality of service (QoS) key performance indicators (KPIs) to the Wi-Fi layer for some important or “business critical” flows. This may result, for example, from the client-side application’s lack of QoS KPI support, from the operating system (OS) platform lacking an application programming interface (API) for specifying QoS KPIs, from the client-side application not implementing proper QoS, or for other reasons. In each of these scenarios, important application traffic may be transmitted using the Best Effort access category (AC_BE) or Background access category (AC_BK). In many instances, this may prevent the deployment from meeting end-to-end (E2E) QoS or service level agreement (SLA) requirements for these important flows.

Meanwhile, APs may generally have knowledge of QoS requirements for important flows because of provisioning, application flow monitoring, or from artificial intelligence predictions provided for applications, such as in the case of web conferencing applications. An AP can use policies to prioritize important flows to meet SLA/QoS requirements. Therefore, an AP may be able to create an SCS stream for a STA for UL or DL and indicate desired prioritization of these flows to the STA, especially in the UL. However, if an AP is allowed to create an SCS stream, collisions with the SCS streams created from the STA may occur and need to be addressed

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a block diagram of a system for AP initiated SCS signaling, according to an embodiment.

FIG. 2 illustrates a flow diagram of a method for AP initiated SCS signaling performed by an AP, according to an embodiment.

FIG. 3 illustrates a flow diagram of a method for AP initiated SCS signaling performed by a STA, according to an embodiment.

FIG. 4A illustrates a set of data fields provided in an AP initiated SCS request as part of an SCS Descriptor List field, according to an embodiment.

FIG. 4B illustrates a QoS Characteristics element included in the AP initiated SCS request, according to an embodiment.

FIG. 4C illustrates a flow with signaling details for an AP initiated SCS procedure, according to an embodiment.

FIG. 4D illustrates capability signaling for the AP initiated SCS, according to an embodiment.

FIG. 4E illustrates a description of bits in a capabilities field, according to an embodiment.

FIG. 5 illustrates a computing system, according to an embodiment.

### DESCRIPTION OF EXAMPLE EMBODIMENTS

### OVERVIEW

One embodiment presented in this disclosure provides a network device including one or more memories and one or more processors communicatively coupled to the one or more memories, where the one or more processors are configured to, individually or collectively, perform operations including transmitting a stream classification service (SCS) request to a station (STA), the SCS request comprising an SCS identifier (SCSID), a traffic classification (TCLAS) information to identify an SCS flow and a quality of service (QoS) characteristics element that indicates information for the STA to perform QoS classification or prioritization for the SCS flow, and receiving an SCS response from the STA.

In one embodiment, the operations further include selecting the SCSID for the SCS flow from an SCSID space, where the SCSID space is split between the network device and the STA or the network device and the STA select the SCSID from opposite directions in the SCSID space.

In one embodiment, the TCLAS information includes at least one of: one or more TCLAS element or a TCLAS Processing element.

In one embodiment, the QoS characteristics element includes a direction subfield set to uplink (UL), and the QoS characteristics element indicates a traffic identifier (TID) or user priority (UP) to be used for mapping the SCS flow.

In one embodiment, the QoS characteristics element further includes delay bound information for the SCS flow.

In one embodiment, the SCS request further includes UL triggering schedule information for the SCS flow indicated in one or more fields of the QoS characteristics element.

In one embodiment, the one or more fields of the QoS characteristics element include one or more of a minimum servicing interval, a maximum servicing interval, or a minimum data rate.

In one embodiment, the operations further include terminating or modifying the SCS flow by transmitting another SCS request to the STA and receiving an SCS response from the STA.

In one embodiment, terminating the SCS flow includes transmitting an SCS request to the STA, the SCS request including the SCSID and a request type field set to indicate removing of the SCS flow.

In one embodiment, modifying the SCS flow includes the transmitting an SCS request to the STA, the SCS request includes the SCSID, a request type field set to indicate changing the SCS flow, and a QoS characteristics element indicating updated QoS information for the SCS flow.

In one embodiment, the network device indicates support for transmitting an SCS request to the STA as a capability, and the STA indicates support for receiving the SCS request transmitted by the network device as a capability.

One embodiment presented in this disclosure provides a wireless device including one or more memories and one or more processors communicatively coupled to the one or more memories, where the one or more processors are configured to, individually or collectively, perform operations including receiving, from an access point (AP), an SCS request, the SCS request comprising an SCSID, a TCLAS information to identify an SCS flow and a QoS characteristics element that indicates information for the wireless device to perform QoS classification or prioritization for the SCS flow, and transmitting, to the AP, an SCS response.

In one embodiment, the QoS characteristics element includes a direction subfield set to uplink (UL), and the QoS characteristics element indicates a traffic identifier (TID) or user priority (UP) to be used for mapping the SCS flow.

In one embodiment, the QoS characteristics element further includes a delay bound information for the SCS flow.

In one embodiment, the operations further include indicating an accept or reject status for the SCS flow in the SCS response to the AP.

In one embodiment, the operations further include the wireless device mapping an accepted SCS flow to the TID indicated in the QoS characteristics element.

In one embodiment, the operations further include prioritizing UL scheduling of an accepted SCS flow based on the delay bound information indicated in the QoS characteristics element.

In one embodiment, the operations further include receiving, by the wireless device, another SCS request from the AP indicating termination or modification of the SCS flow, and transmitting, to the AP, an SCS response.

In one embodiment, the operations further include terminating the SCS flow by transmitting an unsolicited SCS response.

In one embodiment, terminating the SCS flow includes transmitting an unsolicited SCS response to the AP, the unsolicited SCS response including the SCSID and a status field indicating termination of the SCS flow.

### EXAMPLE EMBODIMENTS

Embodiments described herein provide AP initiated SCS signaling, where the SCS stream setup may be initiated by the AP (e.g., instead of by a STA). The AP initiated SCS enables an AP to prioritize important flows in UL at the STA to meet QoS requirements for those flows. Using an AP initiated SCS feature, an AP can indicate UL QoS for specific flows to be used at the STA in UL, for example, by indicating a specific traffic identifier (TID), user priority (UP), or some combination thereof, to be used for mapping the flow in UL or by specifying an UL delay bound that should be met for the flow in UL transmission. The AP can also indicate UL triggering that the AP will perform to meet QoS requirements for the flow to the STA. This may then enable the STA to be awakened to receive UL triggers from the AP for transmission of UL traffic. In embodiments, signaling details may be configured for an AP initiated SCS feature in 802.11 or revisions thereof (e.g., 802.11bn). The signaling features enable an AP to prioritize important traffic flows in UL on the STAs based on an AP defined policy to meet E2E QoS/SLA. Furthermore, collision avoidance mechanisms are provided.

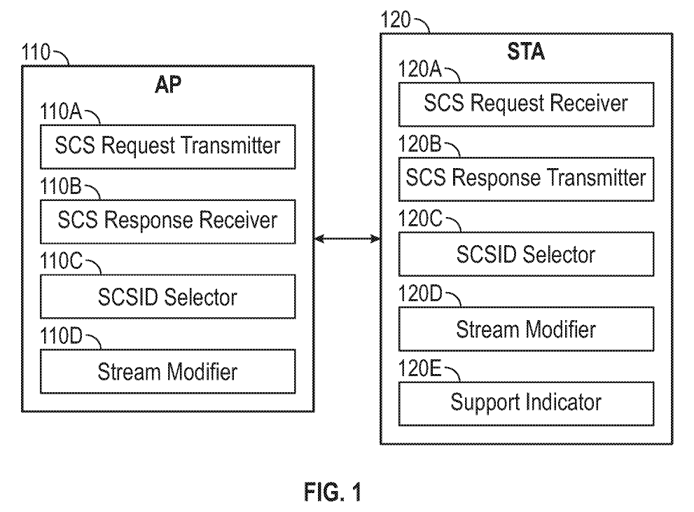

FIG. 1 illustrates a block diagram of a system for AP initiated SCS signaling, according to an embodiment. The system 100 involves communications between an AP 110 and a STA 120. The AP 110 is a network device that connects wireless devices (e.g., non-AP STAs 120) to a network, such as to a local area network or the internet. The STA 120 may be a wireless device of a user, such as a smartphone, laptop, or other wireless device. The AP 110 and STA 120 may exchange messages over Wi-Fi or other IEEE 802.11 wireless medium. Network traffic between the AP 110 and STA 120 can be made more efficient using QoS and SCS mechanisms. In one embodiment, the AP 100 may be an AP multi-link device (MLD), and the STA may be a non-AP MLD.

The AP 110 may comprise an SCS request transmitter 110A, SCS response receiver 110B, SCSID selector 110C, and stream modifier 110D. The SCS request transmitter 110A of the AP 110 transmits SCS requests. In embodiments, the SCS request includes an SCSID, TCLAS element(s) (and optionally TCLAS processing element), and a QoS characteristics (QC) element that indicates information for the STA 120 to perform QoS classification and prioritization of flows in UL. The TCLAS element provides classification of UL flows and the QoS characteristics element may comprise providing UL QoS mapping for flow classification, UL traffic flow characteristics, and scheduling information, UL triggering schedule information, or some combination thereof. The QoS characteristics elements received from the AP (in the AP-Initiated SCS request) may enable the STA 120 to prioritize an UL SCS flow in its scheduling by mapping to an indicated TID in the QC element and/or prioritizing the flow to meet other traffic characteristics e.g. UL Delay Bound.

After the AP 110 sends an SCS request to the STA 120, the AP 110 waits to receive an SCS response. The SCS response receiver 110B receives SCS responses from the STA 120. The SCS response may comprise an indication of whether the SCS request was accepted or rejected by the STA 120.

For each SCS exchange with the STA 120, the SCSID selector 110C of the AP 110 selects an SCSID from a set of values in an SCSID space. For example, the SCSID selector 110C may select an SCSID to assign to the SCS request. In embodiments, the SCSID selector 110C of the AP 110 may select the SCSID according to a collision avoidance mechanism configured for the AP 110 and the STA 120. In one embodiment, the AP 110 and STA 120 may use the SCSID space in a split manner. For example, the SCSID may be represented by a fixed-width binary field (e.g., 8 bits) with bit ordering from the most significant bit (MSB) down to the least significant bit (bit 0). The STA 120 can select SCSIDs with the MSB set to 0, which corresponds to binary patterns for integers between 0 and 127. The AP 110 can select SCSIDs with the MSB set to 1, which corresponds to binary patterns for integers between 128 and 255. As such, the STA 120 and AP 110 select SCSIDs from different ranges in the SCSID space. In another example, the AP 110 may select SCSIDs with MSB=0, while the STA 120 selects SCSIDS with MSB=1.

In one embodiment, the AP 110 and the STA 120 may share the entire SCSID space but increment from opposite directions. The AP 110 and the STA 120 may each select SCSIDs starting from lower and higher parts of the SCSID space respectively, or vice versa. For example, the STA 120 may start using SCSIDs starting from a lowest available SCSID and incrementally increase for each subsequent selection, while the AP 110 may start using SCSIDs starting from the highest available SCSIDs and incrementally decrease for each subsequent selection, or vice versa. As one example, the STA 120 may start selecting SCSIDs starting from value 0 and increment to higher values, and the AP 110 may start selecting SCSIDs starting from value 255 and increment/decrement to lower values. This advantageously avoids any conflicts in SCSID assignment without the AP 110 and STA 120 strictly splitting the SCSID space.

In one embodiment, if an entity (AP 110 or STA 120) receives an SCS Request (with type 'Add') from a peer that includes an SCSID already used for an SCS flow that the entity created earlier, then the entity may be configured to reject the SCS Request with an appropriate status code (e.g. REJECTED_SCSID_ALREADY_USED).

In one embodiment, if the AP 110 receives an SCS Request (with type 'Add') from a STA 120 that includes the same SCSID sent by the AP 110, and for which the AP 110 is waiting on an SCS Response, then the AP 110 may still accept the SCS Request from the STA 120. Then, if the AP 110 receives an SCS Response for the same SCSID with a Rejection status, then the AP 110 may send another AP initiated SCS Request with a new SCSID. If the AP 110 receives an SCS Response with a Success/Accept status from the STA 120 for the SCSID, the AP 110 may terminate the SCS flow by sending an SCS Request with Request type "Remove" for the SCSID and then create a new SCS stream with a different SCSID

In one embodiment, the STA 120 may reject an SCS Request received from an AP 110 having the same SCSID that the STA 120 sent in a preceding SCS Request, and for which the STA 120 is waiting to receive an SCS Response. Alternatively, in this case, STA 120 may accept the SCS request from the AP, and if it receives an SCS Response from the AP for its previous SCS Request (using the same SCSID), then it may terminate that SCS stream, and may create a new SCS stream with a different SCSID (e.g., according to a similar behavior as for the AP above). In embodiments, both AP 110 and STA 120 may maintain the state for each SCS flow whether the flow was created by the STA 120 or by the AP 110.

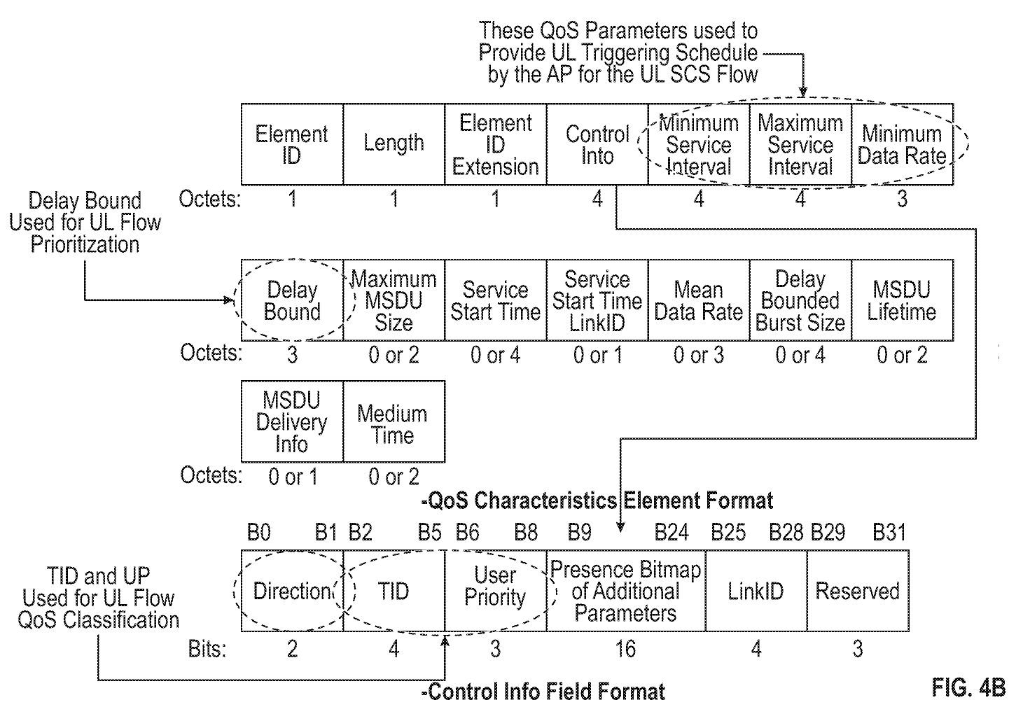

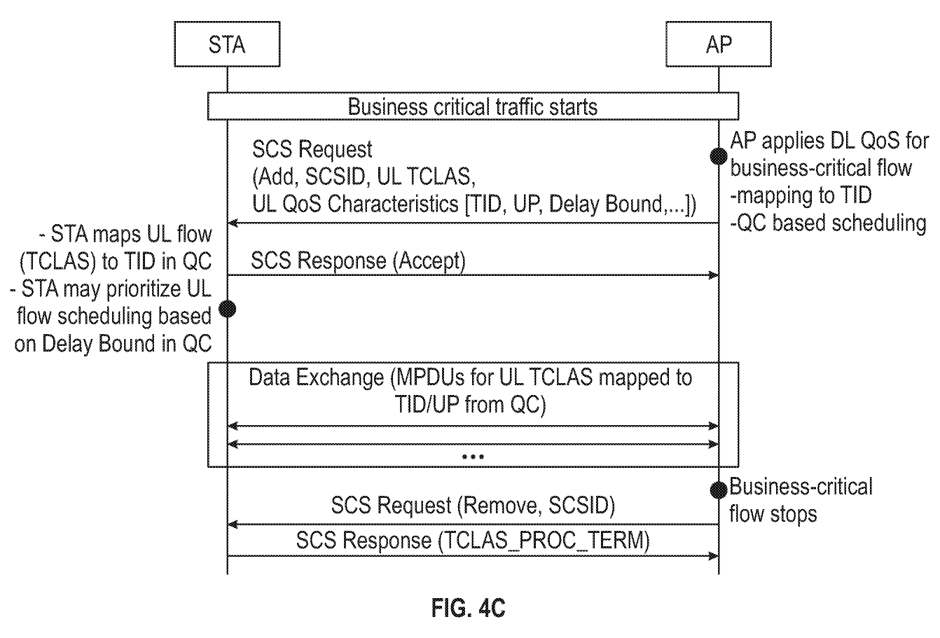

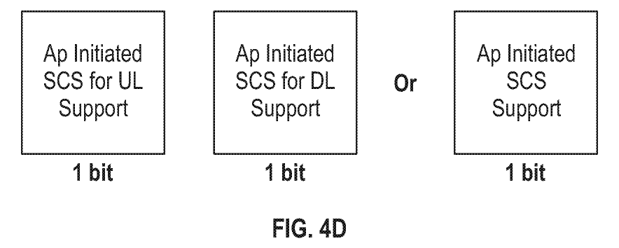

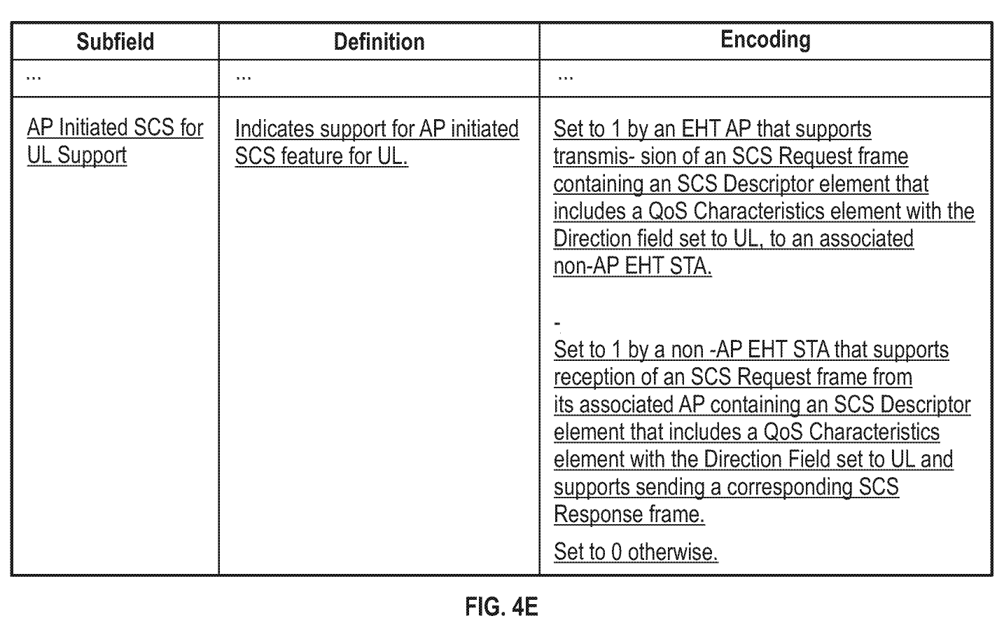

The stream modifier 110D of the AP 110 indicates a termination or modification of the SCS stream in an SCS request, such as for scenarios where the AP 110 may not have enough resources to serve some of the previously created SCS streams or may need to terminate the SCS stream due to policy reasons. For example, the stream modifier 110D may configure the SCS request to include a “Remove” type indicator together with the SCSID to indicate to the STA 120 that the identified flow should be terminated. This may be indicated by sending an SCS request (e.g., with Type “Remove”) to the STA by the AP. As another example, the stream modifier 110D may configure the SCS request to include a “Change” type indicator together with the SCSID to indicate to the STA 120 that the parameters of the identified SCS flow should be modified. This may be indicated by sending an SCS request (e.g., with Type “Change”) to the STA by the AP. Using the SCS request, the AP can terminate or modify an SCS stream that was created by the AP using an AP-initiated SCS procedure. An AP can also terminate an SCS stream that was created by the STA by sending an unsolicited SCS response for that SCSID. The indication of termination or modification of the SCS stream provided by the AP 110 is described in greater detail further below with respect to the description of FIG. 4B.

In one embodiment, the AP 110 may further comprise a support indicator (not shown). In one embodiment, both the STA 120 and AP 110 may indicate support for the AP-Initiated SCS feature. In one embodiment, the support indicator of the AP 110 may indicate support during association with the STA 120. The support may be indicated by extending one or more medium access control (MAC) capabilities field of a capabilities element.

The STA 120 comprises an SCS request receiver 120A, SCS response transmitter 120B, SCSID selector 120C, stream modifier 120D, and support indicator 120E. The SCS request receiver 120A of the STA 120 receives SCS requests sent by the AP 110. The SCS response transmitter of the STA 120 transmits an SCS response to the AP 110. In the SCS response, the STA 120 may provide an approval/acceptance or rejection status to the AP 110. The SCSID selector 120C of the STA 120 selects an SCSID for SCS exchanges with the AP. For example, the STA 120 may determine an SCSID for each SCS flow when it is sending an SCS request to the AP. In embodiments, the SCSID selector 120C of the STA 120 may select an SCSID based on the collision avoidance mechanism previously described.

The stream modifier 120D of the STA 120 indicates a termination or modification of the SCS stream in an SCS response. To terminate an SCS stream that was created by the AP, the STA 120 may be configured to send an unsolicited SCS response comprising an SCSID for the SCS stream created by the AP 110 and appropriate status code that indicates termination of the SCS flow to the AP 110. For example, the STA 120 may decide to terminate an AP created SCS stream due to conflicts with the STA’s local policy.

Upon receiving the unsolicited SCS Response indicating termination of an SCS stream that was created by the AP, the AP 110 may determine that the SCS stream no longer exists at the STA 120. In response, the AP 110 may attempt creation of another SCS stream for the traffic classification (TCLAS) by sending an SCS request (e.g., with type “Add”). Additionally, if for a given flow or TCLAS the STA 120 has created an SCS stream and QoS parameters for the SCS stream that no longer aligns with the AP's policy, the AP 110 may terminate the SCS stream by sending an unsolicited SCS response having an appropriate status code indicating termination of the SCS flow. The AP 110 can then create an SCS stream for the flow/TCLAS with the desired set of QoS parameters using the AP initiated SCS. When an SCS stream that was created by the AP 110 using an AP initiated SCS request is terminated, either by the AP 110 or the STA 120, the STA 120 may be configured to no longer apply the classifier(s) corresponding to the SCS stream.

The support indicator 120E of the STA 120 indicates support for receiving an SCS request transmitted by the AP 110 as a capability. For example, this may be indicated as a capability during association. The support may be indicated by extending one or more medium access control (MAC) capabilities field of a capabilities element. Additional details with respect to indicating support for AP initiated SCS as a capability are provided with respect to the description of FIG. 4D further below.

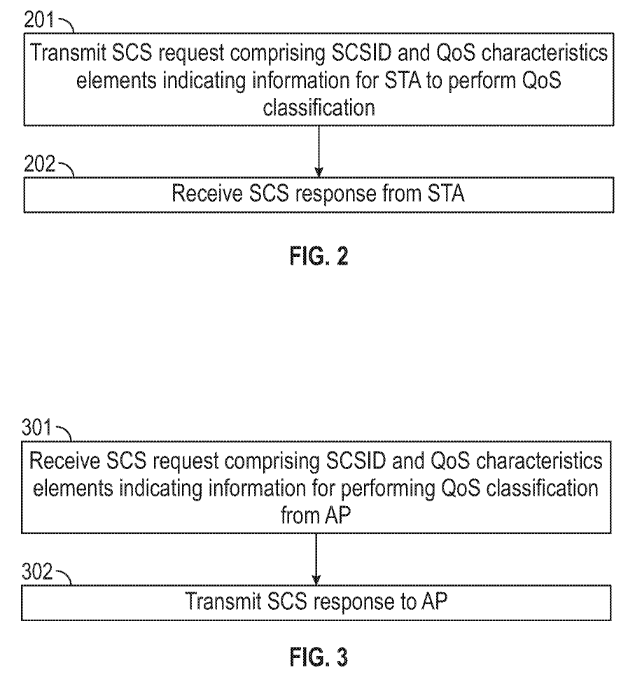

FIG. 2 illustrates a flow diagram of a method for AP initiated SCS signaling performed by an AP, according to an embodiment. At block 201, the AP transmits an SCS request to a STA. The SCS request may comprise an SCSID, a TCLAS element (optionally TCLAS processing element), and QoS characteristics element that indicates information for the STA to perform QoS classification, mapping and QoS prioritization for UL flow. At block 202, the AP receives an SCS response from the STA. The SCS request from the AP may provide information (SCSID, TCLAS, QC, etc.) for one or more UL flows to the STA, for QoS classification, mapping, and QoS prioritization of those UL flows.

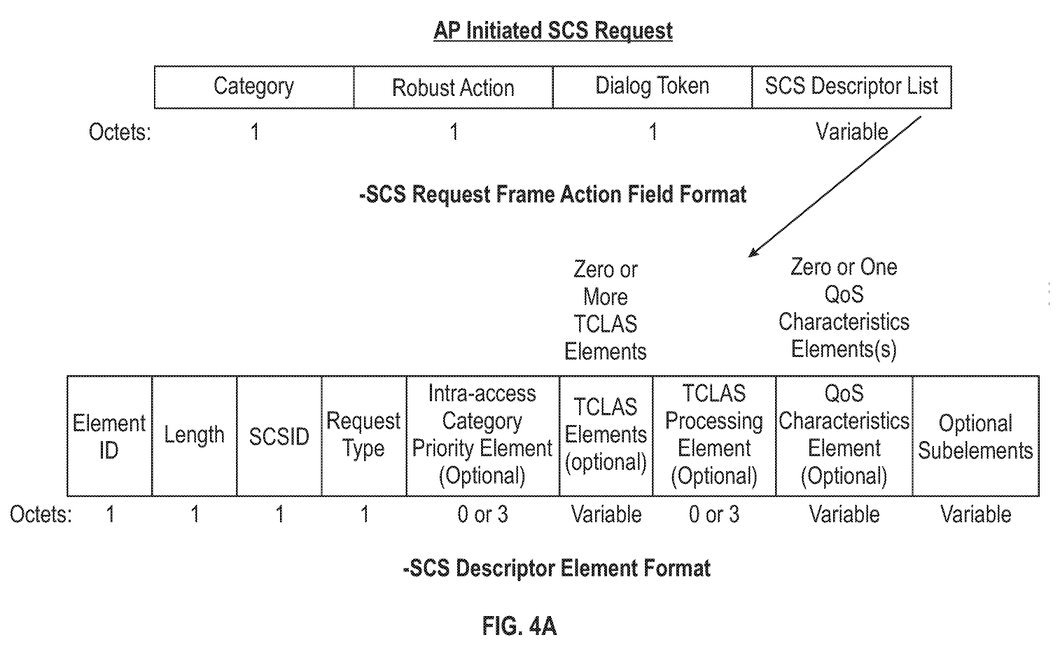

FIG. 3 illustrates a flow diagram of a method for AP initiated SCS signaling performed by a STA, according to an embodiment. At block 301, the STA receives an SCS request from an AP. The SCS request may comprise an SCSID, a TCLAS element (optionally TCLAS processing element) and QoS characteristics element that indicate information for the STA to perform QoS classification, mapping, and QoS prioritization. At block 302, the STA transmits an SCS response to the AP.

FIG. 4A illustrates a set of data fields provided in an AP initiated SCS request as part of an SCS Descriptor List field, according to an embodiment. The SCS Descriptor List field includes one or more SCS Descriptor elements. The data fields in the SCS Descriptor element are used for signaling TCLAS information for UL flow identification, UL QoS classification, UL triggering information to a STA, or some combination thereof. The AP Initiated SCS request may include a set of data fields/elements, such as defined in IEEE 802.11be. In one embodiment, in the SCS request the AP may provide an SCSID, a Request Type field indicating an Add, Change or Remove request types for the SCS flow, TCLAS element(s) and optionally a TCLAS Processing element for identifying the SCS flow, and a QoS Characteristics element for providing QoS information for the SCS flow. An UL SCS flow may be identified by one or more TCLAS elements and optionally a TCLAS processing element, or some combination thereof.

FIG. 4B illustrates a QoS Characteristics element included in the AP initiated SCS request, according to an embodiment. The QoS characteristics element may comprise a direction field, that indicates the direction for the SCS flow e.g., UL or downlink (DL), as indicated in the ‘Control Info’ field of the QoS Characteristics element. In one embodiment, with the direction field set to UL, the QoS characteristics element may comprise information for QoS classification, prioritization, and scheduling information for the matching UL SCS flow (e.g. where matching UL SCS flow is identified based on the TCLAS information included in the SCS request). In an AP initiated SCS request, the AP can provide information for the STA to perform QoS classification for the identified UL SCS flow by including in the QoS characteristics element a TID and user priority (UP) for the UL flow. In one embodiment, the QoS characteristics may comprise Delay Bound information that communicates the delay bound that should be met for the SCS flow in UL and can be used for prioritization of the UL SCS flow in the STA’s scheduling.

In one embodiment, the QoS characteristics element may further comprise UL triggering schedule information. In the AP initiated SCS request, the AP may indicate that it will trigger the STA for transmitting UL traffic for the SCS flow identified in the SCS request. The AP may provide the UL triggering information by including non-zero values for the Minimum Serving Interval, the Maximum Service Interval, the Minimum Data Rate field, or some combination thereof, in the QoS Characteristics element. These fields may be configured to indicate to the STA that the AP will trigger the STA for the SCS flow between the Min and Max Service Interval periods and for meeting the Minimum Data Rate requirement.

In one embodiment, the AP may use an AP initiated SCS request to signal the DL QoS treatment that the AP will apply for an identified DL SCS flow to the STA. The DL QoS information may be provided by the AP as a notification to the STA. In an AP initiated SCS request for DL, the AP may include an SCSID, TCLAS element(s), optionally a TCLAS Processing element identifying the DL SCS flow, and QoS Characteristics element with a direction field set to DL that provides QoS information for the SCS flow. A STA may send a SUCCESS/accept response for an SCS request that provides suitable QoS characteristics for a DL flow.

If the STA decides to setup a different DL QoS for the DL TCLAS indicated in the AP initiated SCS request for a DL SCS flow, the STA can later send an SCS request with a new SCSID and the same TCLAS element(s) requesting the desired QoS Characteristics. In one embodiment, if the AP accepts the STA's SCS request for the DL TCLAS, then the AP may stop applying the AP provided QoS treatment for the SCS flow and terminate the AP created SCS flow. In one embodiment, a STA may reject an SCS request from the AP for a DL if the STA does not approve of the DL QoS that is applied to the identified DL flow. The STA can then send an SCS request with a new SCSID and the same TCLAS element(s), which requests the desired QoS Characteristics for DL flow.

FIG. 4C illustrates a flow with signaling details for an AP initiated SCS procedure, according to an embodiment. Network traffic between the STA and AP may include important or “business critical” traffic flows both in downlink and uplink. For important DL flows, the AP applies DL QoS treatment to prioritize the flows. For prioritization of important DL flows, the AP may map the DL flow to a desired TID and may perform QoS characteristics (QC) based scheduling for the flow to meet QoS requirements of the flow. As described above, the AP may send the DL QoS treatment it is applying for DL flows to the STA using AP initiated SCS as a notification to the STA (not shown in FIG. 4C).

In one embodiment, for important UL flows, the AP may request the STA to prioritize the flow(s) in UL by sending an SCS request that indicates identification of the flow (using TCLAS information), an SCSID for the flow and QoS characteristics element providing QoS classification, traffic characteristics for QoS prioritization, and any UL triggering schedule for the QoS flow (as shown in FIG. 4C). For QoS prioritization of an UL flow at the STA, the AP sends an SCS request, with type “Add”, SCSID, UL TCLAS information, and UL QoS characteristics element (e.g., that includes the TID, UP, Delay Bound, other QoS traffic characteristics or some combination thereof). The STA may send back an SCS response accepting the SCS request and may map the UL flow identified by the TCLAS to the TID indicated in the UL QoS characteristics (QC) element. The STA may further prioritize the UL flow scheduling based on the Delay Bound received in the QoS characteristics element. Data is exchanged between the STA and AP, such as the MAC Protocol Data Units (MPDUs) for the UL TCLAS flow mapped to the TID/UP from the QC element, until the flow stops.

In one embodiment, an AP is configured to send an SCS request (with type “Remove”) to the STA to terminate/remove an SCS stream or flow that the AP had created earlier with the STA. In one embodiment, the AP is configured to send an SCS request (with type “Change”) to change SCS flow parameters for the identified SCS flow and in this case, the AP may include an updated QoS characteristics element in the SCS request, providing updated QoS information for the SCS flow. The AP may terminate or modify either an UL SCS flow or a DL SCS flow that was created earlier by the AP. For example, the AP may send an SCS request (with type “Change”) to change the parameters specified for the UL or DL SCS flow by including an updated QoS characteristics element in the request. In one embodiment, the AP may send an SCS request with request type subfield set to “Change” or “Remove” only for the SCSIDs that were created by the AP and not for the SCSIDs that were created by the STAs. For example, the AP may not be allowed to terminate or change the SCS flows that were created by the STA using the SCS request. In one embodiment, a STA may send an SCS request (with request type set to Change or Remove) only for SCSIDs that the STA created, and not for the SCSIDs that were created by the AP. For example, the STA may not be allowed to terminate or change the SCS flows that were created by the AP using the SCS request.

In one embodiment, when the STA receives an SCS request with Request Type subfield set to “Remove” for an AP created SCSID, the non-AP STA may send an SCS response with the same Dialog Token and SCSID field and Status field set to TCLAS_PROCESSING_TERMINATED (or another suitable status code) as indicated by the SCS Response (TCLAS_PROC_TERM) in FIG. 4C.

In one embodiment, the AP can send an unsolicited SCS response to terminate an SCS stream that was created by the STA (e.g., as defined in a baseline IEEE 802.11 specification), such as when an AP has a resource constraint or due to a policy conflict. In one example, AP can also terminate an SCS stream and suggest updated parameters for the SCS stream in the unsolicited SCS response. In this case, the AP may include QoS characteristics element in an SCS Descriptor element that provides the updated QoS information for the SCS flow.

In one example, the AP may also use a similar procedure as described above to terminate or change SCS streams that were created by the AP itself using the AP initiated SCS procedure. Thus, for an SCS stream that was created using AP initiated SCS, the AP may also send an unsolicited SCS response to the STA that includes the corresponding SCSID and a Status code that indicates termination/removal of the SCS stream. In this case, there may be no response from the STA and the SCS stream is considered as removed at the STA and the AP. In one example, the AP can also send an unsolicited SCS response to the STA that includes an SCSID and with a Status code that indicates a change being made to the SCS stream. In this case, the unsolicited SCS response may also include a QoS characteristics element in an SCS Descriptor element that provides the updated QoS information for the SCS flow, which may be an UL SCS flow or a DL SCS flow, and the Request Type subfield can be set to “Change” in the unsolicited SCS Response.

In one embodiment, for the SCS flows that were created by the AP, the STA can send an unsolicited SCS response to terminate the SCS flow, such as when there is a policy conflict at the STA for the QoS information provided for the SCS flow. The unsolicited SCS response from the STA to terminate the SCS flow may include the SCSID and an appropriate status code indicating termination of the SCS flow, e.g., TCLAS_PROCESSING_TERMINATED_POLICY_CONFLICT. As one example, if a STA is terminating an UL or DL SCS flow that was setup by the AP using an unsolicited SCS response, then the STA may also suggest updated QoS info for the SCS flow by including a QoS characteristics element in an SCS Descriptor element in the response. The AP may follow-up with initiating an AP initiated SCS stream setup with the STA suggested QoS parameters.

FIG. 4D illustrates capability signaling for the AP initiated SCS, according to an embodiment. One or more reserved bits in a capabilities field can be used for indicating support for AP initiated SCS. In one embodiment, an ‘AP initiated SCS for UL Support’ field can be defined to indicate support for AP initiated SCS feature for uplink SCS flows. In addition, another ‘AP initiated SCS for DL Support’ field can be defined to indicate support for AP initiated SCS feature for downlink SCS flows. In one embodiment, a single ‘AP initiated SCS Support’ field can be defined that indicates support for AP initiated SCS feature both for UL and DL SCS flows.

FIG. 4E illustrates a description of bits in a capabilities field, according to an embodiment. In one embodiment, the capabilities field(s) (as described above) for AP initiated SCS feature may be indicated in an extremely high throughput (EHT) MAC capabilities field included in an EHT capabilities element. In embodiments, the EHT MAC capabilities field may be extended to indicate support for the AP initiated SCS feature. For example, a reserved field or subfield may be used to indicate AP initiated SCS for UL Support. When the subfield is set to 1 by the STA, it may indicate that the STA supports reception of an SCS request frame from its associated AP containing an SCS descriptor element that includes a QoS characteristics element with direction field set to UL, and the STA supports sending a corresponding SCS response frame. Otherwise, the subfield may be set to 0. Similarly, when the subfield is set to 1 by an AP, it may indicate that the AP supports transmission of an SCS request frame containing an SCS descriptor element that includes a QoS characteristics element with direction field set to UL to an associated non-AP STA. A similar ‘AP initiated SCS for DL Support’ capability can be indicated in the EHT capabilities element by AP and STA, or a more generic ‘AP initiated SCS Support’ capability can be indicated by AP and STA covering feature support for both UL and DL.

In one embodiment, the capabilities field(s) (as described above) for AP initiated SCS feature may be indicated in a different capabilities element, such as an ultra-high reliability (UHR) capabilities element, Extended capabilities element or another element. In one embodiment, the STA may indicate its support for AP initiated SCS in an association request or reassociation request. As such, the AP may indicate its support in a beacon, probe response, association response, reassociation response, or some combination thereof. In one embodiment, the capability field can be used to indicate generic support (e.g., support for both UL and DL) for AP initiated SCS, rather than indicating support specifically for UL.

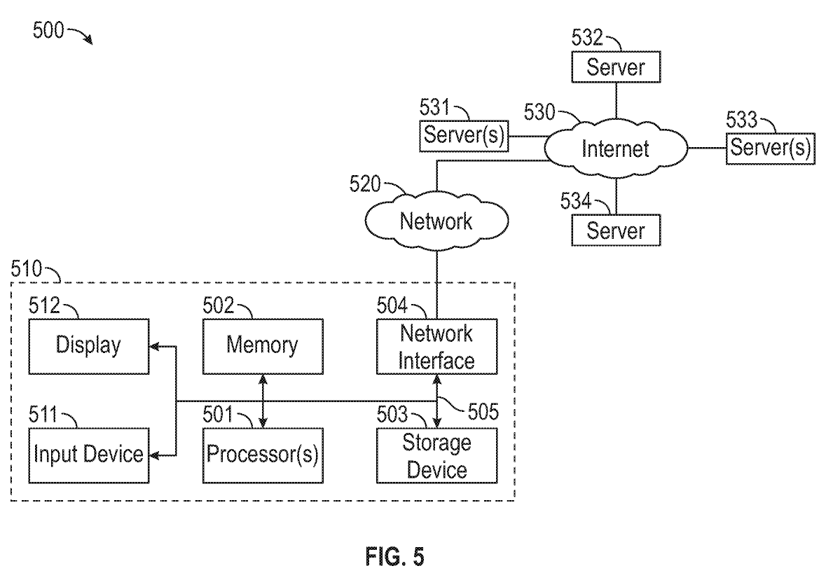

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

To facilitate understanding, identical reference numerals have been used, where possible, to designate identical elements that are common to the figures. It is contemplated that elements disclosed in one embodiment may be beneficially used in other embodiments without specific recitation.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A network device comprising:
one or more memories; and
one or more processors communicatively coupled to the one or more memories, wherein the one or more processors are configured to, individually or collectively, perform operations comprising:
transmitting a stream classification service (SCS) request to a station (STA), the SCS request comprising an SCS identifier (SCSID), a traffic classification (TCLAS) information to identify an SCS flow and a quality of service (QoS) characteristics element that indicates information for the STA to perform QoS classification or prioritization for the SCS flow; and
receiving an SCS response from the STA.

2. The network device of claim 1, wherein the operations further comprise:
selecting the SCSID for the SCS flow from an SCSID space, wherein the SCSID space is split between the network device and the STA or the network device and the STA select the SCSID from opposite directions in the SCSID space.

3. The network device of claim 1, wherein the TCLAS information comprises at least one of: one or more TCLAS element or a TCLAS Processing element.

4. The network device of claim 1, wherein the QoS characteristics element comprises a direction subfield set to uplink (UL), and wherein the QoS characteristics element indicates a traffic identifier (TID) or user priority (UP) to be used for mapping the SCS flow.

5. The network device of claim 4, wherein the QoS characteristics element further comprises delay bound information for the SCS flow.

6. The network device of claim 1, wherein the SCS request further comprises UL triggering schedule information for the SCS flow indicated in one or more fields of the QoS characteristics element.

7. The network device of claim 6, wherein the one or more fields of the QoS characteristics element comprise one or more of a minimum servicing interval, a maximum servicing interval, or a minimum data rate.

8. The network device of claim 1, wherein the operations further comprise:
terminating or modifying the SCS flow by transmitting another SCS request to the STA; and
receiving an SCS response from the STA.

9. The network device of claim 8, wherein terminating the SCS flow comprises transmitting an SCS request to the STA, the SCS request comprising the SCSID and a request type field set to indicate removing of the SCS flow.

10. The network device of claim 8, wherein modifying the SCS flow comprises the transmitting an SCS request to the STA, the SCS request comprising the SCSID, a request type field set to indicate changing the SCS flow, and a QoS characteristics element indicating updated QoS information for the SCS flow.

11. The network device of claim 1, wherein the network device indicates support for transmitting an SCS request to the STA as a capability and the STA indicates support for receiving the SCS request transmitted by the network device as a capability.

12. A wireless device comprising:
one or more memories; and
one or more processors communicatively coupled to the one or more memories, wherein the one or more processors are configured to, individually or collectively, perform operations comprising:
receiving, from an access point (AP), an SCS request, the SCS request comprising an SCSID, a TCLAS information to identify an SCS flow and a QoS characteristics element that indicates information for the wireless device to perform QoS classification or prioritization for the SCS flow; and
transmitting, to the AP, an SCS response.

13. The wireless device of claim 12, wherein the QoS characteristics element comprises a direction subfield set to uplink (UL), and wherein QoS characteristics element indicates a traffic identifier (TID) or user priority (UP) to be used for mapping the SCS flow.

14. The wireless device of claim 13, wherein the QoS characteristics element further comprises a delay bound information for the SCS flow.

15. The wireless device of claim 12, wherein the operations further comprise indicating an accept or reject status for the SCS flow in the SCS response to the AP.

16. The wireless device of claim 12, wherein the operations further comprise the wireless device mapping an accepted SCS flow to the TID indicated in the QoS characteristics element.

17. The wireless device of claim 12, wherein the operations further comprise prioritizing UL scheduling of an accepted SCS flow based on the delay bound information indicated in the QoS characteristics element.

18. The wireless device of claim 12, wherein the operations further comprise:
receiving, by the wireless device, another SCS request from the AP indicating termination or modification of the SCS flow, and
transmitting, to the AP, an SCS response.

19. The wireless device of claim 12, wherein the operations further comprise:
terminating the SCS flow by transmitting an unsolicited SCS response.

20. The wireless device of claim 19, wherein terminating the SCS flow comprises transmitting an unsolicited SCS response to the AP, the unsolicited SCS response comprising the SCSID and a status field indicating termination of the SCS flow.
